(19) United States
(12) Patent Application Publication
(10) Pub. No.: US 2014/0286495 A1
(43) Pub. Date: Sep. 25, 2014

(54) ACOUSTIC OUTPUT APPARATUS

(71) Applicant: KABUSHIKI KAISHA TOSHIBA, Minato-ku (JP)

(72) Inventors: Fumihiko Eya, Kawasaki-Shi (JP); Kazunori Fukudome, Yokohama-Shi (JP)

(73) Assignee: KABUSHIKI KAISHA TOSHIBA, Minato-ku (JP)

(21) Appl. No.: 14/021,611

(22) Filed: Sep. 9, 2013

(30) Foreign Application Priority Data
Mar. 21, 2013 (JP) 2013-058522

(51) Int. Cl. H04R 29/00; H04R 3/00

(52) U.S. Cl. CPC H04R 29/001; H04R 3/00
USPC 381/58

(57) ABSTRACT

The acoustic output apparatus includes an output converter that converts an input signal into a plurality of converted signals and outputs the converted signals. The acoustic output apparatus includes a plurality of amplifiers that are provided in a one-to-one relationship with the plurality of converted signals and controlled by the output converter and each of which outputs an output signal obtained by amplifying the converted signal input thereto from the output converter to a load connected to an output thereof. The acoustic output apparatus includes a detector that outputs a detection result to the output converter if the detector detects a failure at the output of any of the plurality of amplifiers.

### CROSS-REFERENCE TO RELATED APPLICATION

This application is based upon and claims the benefit of priority from the prior Japanese Patent Application No. 2013-058522, filed on Mar. 21, 2013, the entire contents of which are incorporated herein by reference.

### BACKGROUND

1. Field

Embodiments of the present invention relate to an acoustic output apparatus.

2. Background Art

There is a system that drives one device with a plurality of outputs.

### BRIEF DESCRIPTION OF THE DRAWINGS

FIG. 1 is a diagram showing an example of a configuration of an acoustic output apparatus 100 according to a first embodiment;

FIG. 2 is a diagram showing an example of a state of the acoustic output apparatus 100 shown in FIG. 1 in which a failure occurs at the output of the first amplifier “Amp1”; and

FIG. 3 is a diagram showing an example of a configuration of an acoustic output apparatus 200 according to a second embodiment. Note that the same reference symbols as those in FIG.

### DETAILED DESCRIPTION

An acoustic output apparatus according to an embodiment includes an output converter that converts an input signal into a plurality of converted signals and outputs the converted signals. The acoustic output apparatus includes a plurality of amplifiers that are provided in a one-to-one relationship with the plurality of converted signals and controlled by the output converter and each of which outputs an output signal obtained by amplifying the converted signal input thereto from the output converter to a load connected to an output thereof. The acoustic output apparatus includes a detector that outputs a detection result to the output converter if the detector detects a failure at the output of any of the plurality of amplifiers.

If the detector detects a failure at the output of an amplifier of the plurality of amplifiers, the output converter stops an operation of the amplifier at the output of which the failure is detected, and generates the converted signals to be output to the remaining amplifiers of the plurality of amplifiers at the outputs of which no failure is detected so as to bring first acoustic characteristics is stopped close to second acoustic characteristics, the first acoustic characteristics being characteristics with respect to the input signal of a synthetic signal of the output signals flowing to the loads after the operation of the amplifier at the output of which the failure is detected, and the second acoustic characteristics being characteristics with respect to the input signal of a synthetic signal of the output signals flowing to the loads before the failure at the output is detected.

In the following, as an example, embodiments will be described with regard to a case where there are three sets of a converted signal output from an output converter, an amplifier and a load (voice coil).

However, the following description holds true for cases where there are two sets or four or more sets of a converted signal output from an output converter, an amplifier and a load (voice coil).

In the following, the embodiments will be described with reference to the drawings.

### First Embodiment

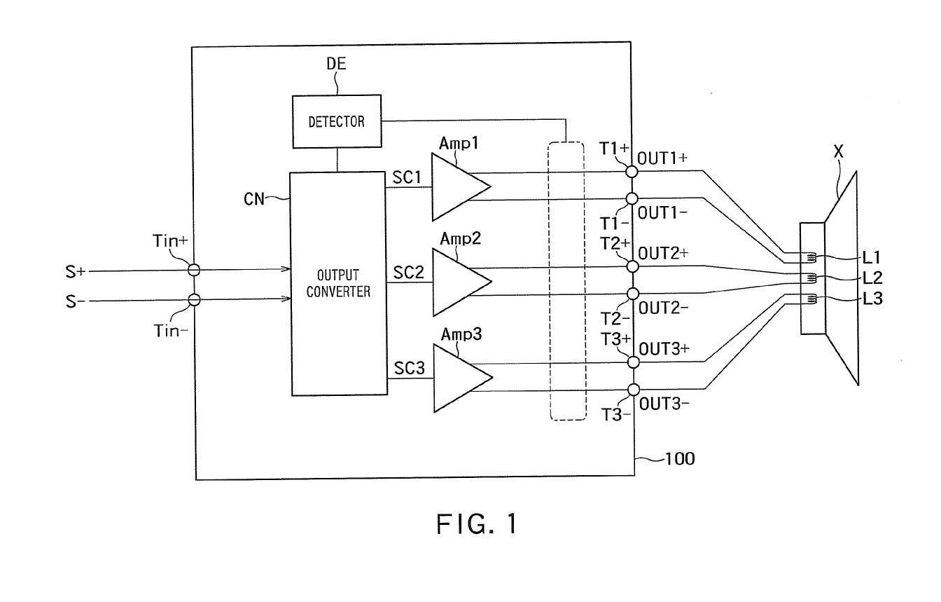

FIG. 1 is a diagram showing an example of a configuration of an acoustic output apparatus 100 according to a first embodiment.

As shown in FIG. 1, the acoustic output apparatus 100 includes input terminals “Tin+” and “Tin−”, a plurality of output terminals “T1+”, “T1−”, “T2+”, “T2−”, “T3+” and “T3−”, an output converter “CN”, a plurality of amplifiers “Amp1” to “Amp3” and a detector “DE”.

The input terminals “Tin+” and “Tin−” are configured to receive input signals “S+” and “S−”, which are music signals.

Although the input signals “S+” and “S−” are analog signals, the input signals “S+” and “S−” may be digital signals. Furthermore, although the input signals “S+” and “S−” are differential signals in this embodiment, the input signals “S+” and “S−” may be single-phase signals. Furthermore, the number of input lines through which the input signals are input is not limited to two, but three or more input lines may be provided.

The output terminals “T1+”, “T1−”, “T2+”, “T2−”, “T3+” and “T3−” are configured to output signals “OUT1+”, “OUT1−”, “OUT2+”, “OUT2−”, “OUT3+” and “OUT3−”. The output signals “OUT1+” and “OUT1−”, the output signals “OUT2+” and “OUT2−” and the output signals “OUT3+” and “OUT3−” are respective differential signals.

A load “L1” is connected between the output terminals “T1+” and “T1−”. A load “L2” is connected between the output terminals “T2+” and “T2−”. A load “L3” is connected between the output terminals “T3+” and “T3−”.

Note that the loads “L1” to “L3” are voice coils of a speaker “X” as shown in FIG. 1, for example. In response to the output signals “OUT1+”, “OUT1−”, “OUT2+”, “OUT2−”, “OUT3+” and “OUT3−” supplied to the loads (voice coils) “L1” to “L3”, the speaker “X” outputs a sound responsive to the input signals “S+” and “S−”.

The output converter “CN” is configured to convert the input signals “S+” and “S−” into a plurality of converted signals “SC1” to “SC3” and output the converted signals “SC1” to “SC3”.

Note that although the converted signals “SC1” to “SC3” are analog signals, the converted signals “SC1” to “SC3” may be digital signals.

That is, the output converter “CN” performs digital-to-analog conversion, analog-to-digital conversion, digital-to-digital conversion or analog-to-analog conversion of the input signals “S+” and “S−” and outputs the resulting signals as the converted signals “SC1” to “SC3”.

Therefore, the output converter “CN” is configured by an AD converter, a DAC with a plurality of outputs, or simply an adder, for example.

The plurality of amplifiers “Amp1” to “Amp3” are provided in a one-to-one relationship with, and associated with, the plurality of converted signals “SC1” to “SC3”.

The plurality of amplifiers “Amp1” to “Amp3” are controlled by the output converter “CN” and configured to output the output signals “OUT1+”, “OUT1−”, “OUT2+”, “OUT2−”, “OUT3+” and “OUT3−”, which are obtained by amplifying the converted signals “SC1” to “SC3” input thereto from the output converter “CN”, to the loads “L1” to “L3” connected to their respective outputs.

More specifically, the amplifier “Amp1” is configured to receive the converted signal “SC1” and output the output signals “OUT1+” and “OUT1−”, which are obtained by amplifying the converted signal “SC1”, to the load (voice coil) “L1” via the output terminals “T1+” and “T1−”.

The amplifier “Amp2” is configured to receive the converted signal “SC2” and output the output signals “OUT2+” and “OUT2−”, which are obtained by amplifying the converted signal “SC2”, to the load (voice coil) “L2” via the output terminals “T2+” and “T2−”.

The amplifier “Amp3” is configured to receive the converted signal “SC3” and output the output signals “OUT3+” and “OUT3−”, which are obtained by amplifying the converted signal “SC3”, to the load (voice coil) “L3” via the output terminals “T3+” and “T3−”.

The detector “DE” is configured to monitor the outputs of the plurality of amplifiers “Amp1” to “Amp3” and output a detection result to the output converter “CN” if the detector “DE” detects a failure at an output.

For example, the detector “DE” is configured to monitor currents flowing through or voltages applied to wires between the outputs of the plurality of amplifiers “Amp1” to “Amp3” and the output terminals to which the loads “L1” to “L3” are connected. The detector “DE” detects a failure at the outputs of the amplifiers “Amp1” to “Amp3” based on the result of monitoring of the currents flowing through the wires or the voltages applied to the wires.

The failure described above may be a degradation (breakdown) of characteristics of an element forming the amplifier “Amp1” to “Amp3” or a break or short-circuit of a wire, for example. If such a failure occurs, the current flowing through or the voltage applied to the wire changes beyond a predetermined value. Thus, the detector “DE” detects a failure at the outputs of the amplifiers “Amp1” to “Amp3” by comparing the monitored current or voltage with a threshold, for example.

Note that the detector “DE” may be configured to output the detection result to the outside of the acoustic output apparatus 100. Alternatively, the detector “DE” may be configured to display the detection result to the outside of the acoustic output apparatus 100.

If the detector “DE” detects a failure at the output of any of the plurality of amplifiers “Amp1” to “Amp3”, the output converter “CN” is configured to stop the operation of the amplifier “Amp1” at the output of which the failure is detected.

The output converter “CN” is further configured to generate the converted signals for the remaining amplifiers “Amp2” and “Amp3” so as to bring the first acoustic characteristics (distortion characteristics, for example) close to the second acoustic characteristics. The first acoustic characteristics is characteristics with respect to the input signals “S+” and “S−” of a synthetic signal of the output signals flowing to the loads after the operation of the amplifier is stopped at the output of which a failure is detected. The second acoustic characteristics is characteristics with respect to the input signals “S+” and “S−” of a synthetic signal of the output signals flowing to the loads before the failure at the output is detected.

For example, if the detector “DE” detects a failure at the output of the amplifier “Amp1” of the plurality of amplifiers “Amp1” to “Amp3”, the output converter “CN” is configured to convert the input signals “S+” and “S−” to generate only the converted signals “SC2” and “SC3”, which are to be output to the remaining amplifiers “Amp2” and “Amp3” of the plurality of amplifiers “Amp1” to “Amp3” at the outputs of which no failure is detected.

More specifically, if the detector “DE” detects a failure at the output of the amplifier “Amp1” of the plurality of amplifiers “Amp1” to “Amp3”, for example, the output converter “CN” is configured to generate the converted signals so as to change the operating frequencies of the remaining amplifiers of the plurality of amplifiers “Amp1” to “Amp3” at the outputs of which no failure is detected.

Alternatively, the output converter “CN” may generate the converted signals “SC2” and “SC3” so as to improve the quantization precision of the remaining amplifiers “Amp2” and “Amp3” or decrease the output frequencies of the remaining amplifiers “Amp2” and “Amp3”.

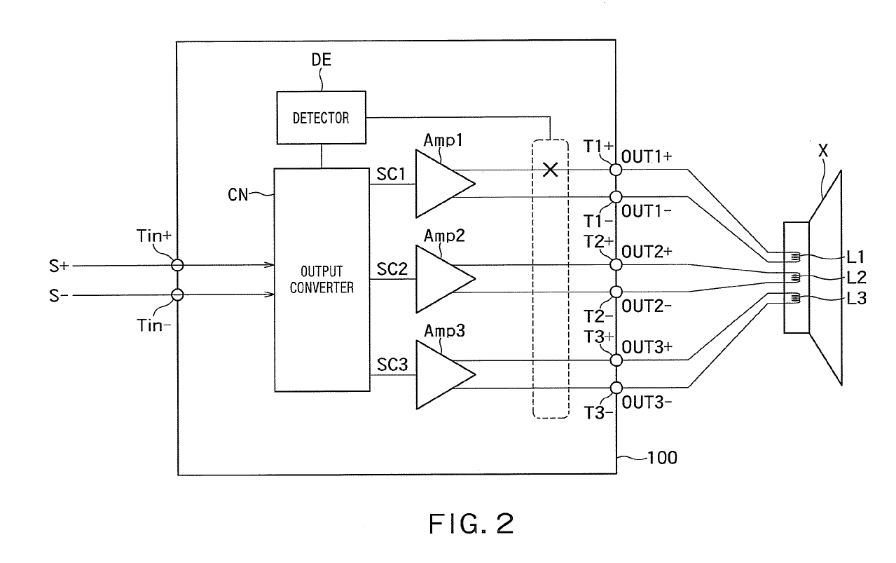

Next, an example of an operation of the acoustic output apparatus 100 configured as described above to compensate for an output degradation will be described. FIG. 2 is a diagram showing an example of a state of the acoustic output apparatus 100 shown in FIG. 1 in which a failure occurs at the output of the first amplifier “Amp1”. Note that, although an operation of the acoustic output apparatus 100 in the case where a failure occurs at the output of the first amplifier “Amp1” will be described below with reference to FIG. 2, the same description holds true for a case where a failure occurs at the output of the second amplifier “Amp2” or the third amplifier “Amp3”.

First, the detector “DE” monitors the outputs of the plurality of amplifiers “Amp1” to “Amp3” and outputs the detection result to the output converter “CN” upon detecting a failure at the output of the amplifier “Amp1” (FIG. 2).

As described above, the detector “DE” may display the detection result to the outside of the acoustic output apparatus 100. Alternatively, the detector “DE” may display the detection result to the outside of the acoustic output apparatus 100.

Then, in response to the detection result that the detector “DE” has detected a failure at the output of the amplifier “Amp1”, the output converter “CN” stops of the operation of the amplifier “Amp1” at the output of which a failure is detected.

Furthermore, the output converter “CN” generates the converted signals “SC2” and “SC3”, which are to be output to the remaining amplifiers “Amp2” and “Amp3”, so as to bring the first acoustic characteristics close to the second acoustic characteristics. The first acoustic characteristics is characteristics with respect to the input signals “S+” and “S−” of a synthetic signal of the output signals “OUT2+”, “OUT2−”, “OUT3+” and “OUT3−” flowing to the loads “L2” and “L3” after the operation of the amplifier “Amp1” is stopped. The second acoustic characteristics is characteristic with respect to the input signals “S+” and “S−” of a synthetic signal of the output signals “OUT1+”, “OUT1−”, “OUT2+”, “OUT2−”, “OUT3+” and “OUT3−” flowing to the loads “L1” to “L3” before the failure at the output is detected.

More specifically, if the detector “DE” detects a failure at the output of the amplifier “Amp1”, the output converter “CN” generates the converted signals “SC2” and “SC3” so as to change the operating frequencies of the remaining amplifiers “Amp2” and “Amp3”.

As another example, the output converter “CN” may generate the converted signals “SC2” and “SC3” so as to improve the quantization precision of the remaining amplifiers “Amp2” and “Amp3” or decrease the output frequencies of the remaining amplifiers “Amp2” and “Amp3”.

Then, the amplifiers “Amp2” and “Amp3” output the output signals “OUT2+” and “OUT2−” and the output signals “OUT3+” and “OUT3−”, which are obtained by amplifying the converted signals “SC2” and “SC3” input thereto from the output converter “CN”, to the loads “L2” and “L3” connected to the respective outputs.

In response to the output signals “OUT2+”, “OUT2−”, “OUT3+” and “OUT3−” supplied to the loads (voice coils) “L2” and “L3”, the speaker “X” outputs a sound responsive to the input signals “S+” and “S−”.

Due to the operation of the output converter “CN” described above, the first acoustic characteristics of the synthetic signal of the output signals flowing to the loads “L2” and “L3” with respect to the input signals “S+” and “S−” are set to be close to the second acoustic characteristics with respect to the input signals “S+” and “S−” of the synthetic signal of the output signals flowing to the loads “L1” to “L3” before the failure at the output is detected.

Therefore, a degradation of the acoustic characteristics (distortion characteristics, for example) can be reduced, and the influence of a failure can be minimized.

As described above, the acoustic output apparatus according to the first embodiment can compensate for an output degradation when an output failure occurs.

### Second Embodiment

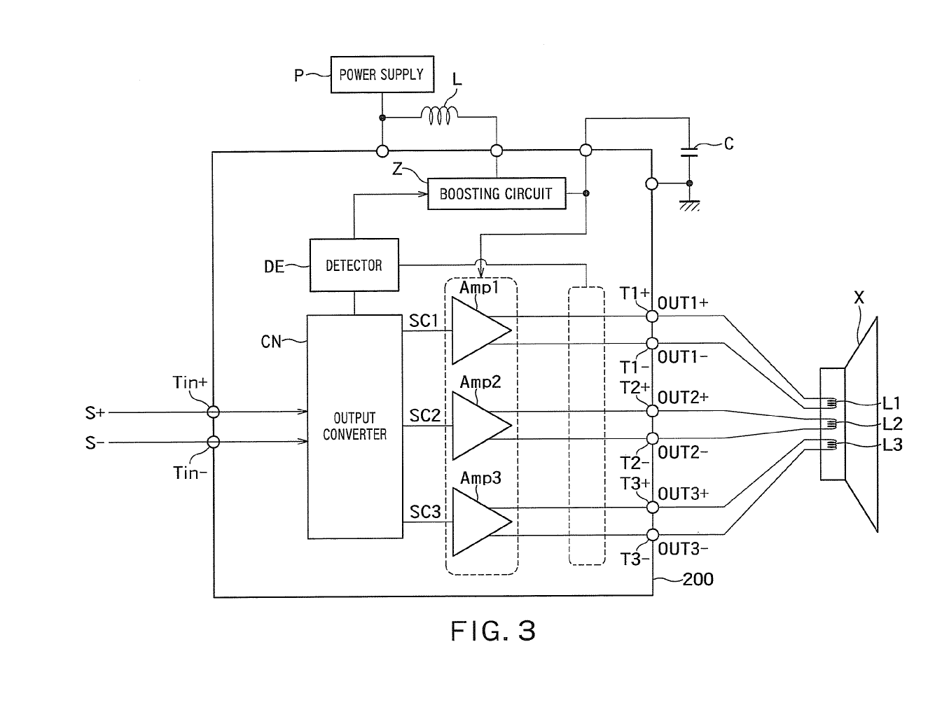

FIG. 3 is a diagram showing an example of a configuration of an acoustic output apparatus 200 according to a second embodiment. Note that the same reference symbols as those in FIG. 1 denote the same components as those in the first embodiment. FIG. 3 shows an example of a state of the acoustic output apparatus 200 in which a failure occurs at the output of the first amplifier “Amp1”.

As shown in FIG. 3, the acoustic output apparatus 200 includes the input terminals “Tin+” and “Tin−”, the plurality of output terminals “T1+”, “T1−”, “T2+”, “T2−”, “T3+” and “T3−”, the output converter “CN”, the plurality of amplifiers “Amp1” to “Amp3”, the detector “DE” and a boosting circuit “Z”.

As can be seen, compared with the acoustic output apparatus 100 according to the first embodiment, the acoustic output apparatus 200 further includes the boosting circuit “Z”.

The boosting circuit “Z” is configured to boost a power supply voltage and supply the boosted power supply voltage to the plurality of amplifiers “Amp1” to “Amp3”.

Furthermore, the boosting circuit “Z” is configured to receive the above-described detection result from the detector “DE”.

Note that, as shown in FIG. 3, the power supply voltage is supplied from a power supply “P” to the boosting circuit “Z” via a coil “L”. A capacitor “C” connected to an output of the boosting circuit “Z” is intended to smooth the boosted voltage.

The amplitudes of the signals output from the plurality of amplifiers “Amp1” to “Amp3” increase as the boosted voltage supplied from the boosting circuit “Z” increases.

If the detector “DE” detects a failure at the output of an amplifier of the plurality of amplifiers “Amp1” to “Amp3”, the boosting circuit “Z” is configured to increase the boosted voltage to be supplied to the remaining amplifiers of the plurality of amplifiers “Amp1” to “Amp3” at the outputs of which no failure is detected.

The remainder of the configuration of the acoustic output apparatus 200 is the same as that of the acoustic output apparatus 100 according to the first embodiment.

Next, an example of an operation of the acoustic output apparatus 200 configured as described above to compensate for an output degradation will be described.

First, the detector “DE” monitors the outputs of the plurality of amplifiers “Amp1” to “Amp3” and outputs the detection result to the output converter “CN” and the boosting circuit “Z” upon detecting a failure at the output of the amplifier “Amp1” (FIG. 3).

Then, in response to the detection result that the detector “DE” has detected a failure at the output of the amplifier “Amp1”, the output converter “CN” stops of the operation of the amplifier “Amp1” at the output of which a failure is detected.

Furthermore, the output converter “CN” generates the converted signals “SC2” and “SC3”, which are to be output to the remaining amplifiers “Amp2” and “Amp3” of the plurality of amplifiers “Amp1” to “Amp3” at the outputs of which no failure is detected, so as to bring the first acoustic characteristics close to the second acoustic characteristics. The first acoustic characteristics is characteristic with respect to the input signals “S+” and “S−” of a synthetic signal of the output signals “OUT2+”, “OUT2−”, “OUT3+” and “OUT3−” flowing to the loads, “L2” and “L3” after the operation of the amplifier “Amp1” is stopped. The second acoustic characteristics is characteristics with respect to the input signals “S+” and “S−” of a synthetic signal of the output signals “OUT1+”, “OUT1−”, “OUT2+”, “OUT2−”, “OUT3+” and “OUT3−” flowing to the loads “L1” to “L3” before the failure at the output is detected.

Furthermore, in response to the detection result that the detector “DE” has detected a failure at the output of the amplifier “Amp1” of the plurality of amplifiers “Amp1” to “Amp3”, the boosting circuit “Z” increases the boosted voltage to be supplied to the remaining amplifiers “Amp2” and “Amp3” of the plurality of amplifier “Amp1” to “Amp3” at the outputs of which no failure is detected.

As a result, the amplitudes of the signals output from the amplifiers “Amp2” and “Amp3” increase as the boosted voltage supplied from the boosting circuit “Z” increases.

Then, the amplifiers “Amp2” and “Amp3” output the output signals “OUT2+” and “OUT2−” and the output signals “OUT3+” and “OUT3−”, which are obtained by amplifying the converted signals “SC2” and “SC3” input thereto from the output converter “CN”, to the loads “L2” and “L3” connected to the respective outputs.

In response to the output signals “OUT2+”, “OUT2−”,

“OUT3+” and “OUT3−” supplied to the loads (voice coils) “L2” and “L3”, the speaker “X” outputs a sound responsive to the input signals “S+” and “S−”.

Due to the operation of the output converter “CN” described above, the first acoustic characteristics of the synthetic signal of the output signals flowing to the loads “L2” and “L3” with respect to the input signals “S+” and “S−” are set to be close to the second acoustic characteristics with respect to the input signals “S+” and “S−” of the synthetic signal of the output signals flowing to the loads “L1” to “L3” before the failure at the output is detected.

In addition, the amplitudes of the signals output from the amplifiers “Amp2” and “Amp3” increase as the boosted voltage supplied from the boosting circuit “Z” increases. That is, the maximum amplitude voltage per output is increased when a failure occurs.

Therefore, a decrease of the output level can be suppressed while reducing a degradation of the acoustic characteristics (distortion characteristics, for example), and the influence of a failure can be minimized.

The remainder of the operation of the acoustic output apparatus 200 is the same as that of the acoustic output apparatus 100 according to the first embodiment.

That is, the acoustic output apparatus 200 according to the second embodiment can compensate for an output degradation to more effectively suppress a degradation of the characteristics when an output failure occurs.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An acoustic output apparatus, comprising:
an output converter that converts an input signal into a plurality of converted signals and outputs the converted signals;
a plurality of amplifiers that are provided in a one-to-one relationship with the plurality of converted signals and controlled by the output converter and each of which outputs an output signal obtained by amplifying the converted signal input thereto from the output converter to a load connected to an output thereof; and
a detector that outputs a detection result to the output converter if the detector detects a failure at the output of any of the plurality of amplifiers,
wherein if the detector detects a failure at the output of an amplifier of the plurality of amplifiers, the output converter
stops an operation of the amplifier at the output of which the failure is detected, and
generates the converted signals to be output to the remaining amplifiers of the plurality of amplifiers at the outputs of which no failure is detected so as to bring first acoustic characteristics close to second acoustic characteristics, the first acoustic characteristics being characteristics with respect to the input signal of a synthetic signal of the output signals flowing to the loads after the operation of the amplifier is stopped at the output of which the failure is detected, and the second acoustic characteristics being characteristics with respect to the input signal of a synthetic signal of the output signals flowing to the loads before the failure at the output is detected.

2. The acoustic output apparatus according to claim 1, wherein if the detector detects a failure at the output of an amplifier of the plurality of amplifiers, the output converter
generates the converted signals so as to change operating frequencies of the remaining amplifiers of the plurality of amplifiers at the outputs of which no failure is detected.

3. The acoustic output apparatus according to claim 1, further comprising:
a boosting circuit that boosts a power supply voltage and supplies the boosted power supply voltage to each of the plurality of amplifiers,
wherein amplitudes of the signals output from the plurality of amplifiers increase as the boosted voltage increases, and
if the detector detects a failure at the output of an amplifier of the plurality of amplifiers, the boosting circuit
increases the boosted voltage to be supplied to the remaining amplifiers of the plurality of amplifiers at the outputs of which no failure is detected.

4. The acoustic output apparatus according to claim 2, further comprising:
a boosting circuit that boosts a power supply voltage and supplies the boosted power supply voltage to each of the plurality of amplifiers,
wherein amplitudes of the signals output from the plurality of amplifiers increase as the boosted voltage increases, and
if the detector detects a failure at the output of an amplifier of the plurality of amplifiers, the boosting circuit
increases the boosted voltage to be supplied to the remaining amplifiers of the plurality of amplifiers at the outputs of which no failure is detected.

5. The acoustic output apparatus according to claim 1, wherein the detector
detects a failure at the outputs of the amplifiers by monitoring a current flowing through or a voltage applied to wires between the outputs of the plurality of amplifiers and output terminals to which the loads are connected.

6. The acoustic output apparatus according to claim 2, wherein the detector
detects a failure at the outputs of the amplifiers by monitoring a current flowing through or a voltage applied to wires between the outputs of the plurality of amplifiers and output terminals to which the loads are connected.

7. The acoustic output apparatus according to claim 3, wherein the detector
detects a failure at the outputs of the amplifiers by monitoring a current flowing through or a voltage applied to wires between the outputs of the plurality of amplifiers and output terminals to which the loads are connected.

8. The acoustic output apparatus according to claim 1, wherein the loads are voice coils of a speaker.

9. The acoustic output apparatus according to claim 1, wherein the input signals are music signals.

10. The acoustic output apparatus according to claim 1, wherein if the detector detects a failure at the output of an amplifier of the plurality of amplifiers, the output converter
converts the input signal to generate only the converted signals to be output to the remaining amplifiers of the plurality of amplifiers at the outputs of which no failure is detected.

11. The acoustic output apparatus according to claim 2, wherein if the detector detects a failure at the output of an amplifier of the plurality of amplifiers, the output converter
converts the input signal to generate only the converted signals to be output to the remaining amplifiers of the plurality of amplifiers at the outputs of which no failure is detected.

12. The acoustic output apparatus according to claim 3, wherein if the detector detects a failure at the output of an amplifier of the plurality of amplifiers, the output converter
converts the input signal to generate only the converted signals to be output to the remaining amplifiers of the plurality of amplifiers at the outputs of which no failure is detected.

13. The acoustic output apparatus according to claim 1, wherein the detector outputs the detection result to an outside of the acoustic output apparatus.

14. The acoustic output apparatus according to claim 2, wherein the detector outputs the detection result to an outside of the acoustic output apparatus.

15. The acoustic output apparatus according to claim 3, wherein the detector outputs the detection result to an outside of the acoustic output apparatus.

16. The acoustic output apparatus according to claim 1, wherein the output converter that performs digital-to-analog conversion, analog-to-digital conversion, digital-to-digital conversion or analog-to-analog conversion of the input signals and outputs the resulting signals as the converted signals.

17. The acoustic output apparatus according to claim 2, wherein the output converter that performs digital-to-analog conversion, analog-to-digital conversion, digital-to-digital conversion or analog-to-analog conversion of the input signals and outputs the resulting signals as the converted signals.

18. The acoustic output apparatus according to claim 3, wherein the output converter that performs digital-to-analog conversion, analog-to-digital conversion, digital-to-digital conversion or analog-to-analog conversion of the input signals and outputs the resulting signals as the converted signals.

19. The acoustic output apparatus according to claim 1, wherein the output converter generate the converted signals so as to improve a quantization precision of the remaining amplifiers.

20. The acoustic output apparatus according to claim 1, wherein the output converter decreases output frequencies of the remaining amplifiers.
